(19) United States
(12) Patent Application Publication
(10) Pub. No.: US 2008/0140736 A1
(43) Pub. Date: Jun. 12, 2008

(54) Hardware-Initiated Automated Back-Up of Data from an Internal Memory of a Hand-Portable Electronic Device

(76) Inventor: Luttinen Jarno, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/793,845

(22) PCT Filed: Dec. 24, 2004
(86) PCT No.: PCT/IB04/04373

§ 371 Date: Jun. 22, 2007

(51) Int. Cl. G06F 17/30; G06F 3/048

(52) U.S. Cl. 707/204; 715/771; 707/E17.007

(57) ABSTRACT

A hand-portable electronic device configured for hardware-initiated automated back-up, comprising: an internal memory for storing data; an interface for connection and disconnection to any one of a plurality of generic memory modules; a user interface that enables a user of the device to specify the generic memory module connected to the interface for automated back-up of data stored in the internal memory; a controller for automatically backing up data, on connection of a generic memory module to the interface, from the internal memory to the connected generic memory module if the connected generic memory module is identified as a generic memory module that has previously been specified for back-up via the user interface.

### FIELD OF THE INVENTION

Embodiments of the present invention relate to hardware-initiated automated back-up of data from an internal memory of hand-portable electronic device. In particular, embodiments of the invention relate to methods for backing-up data from internal memories of hand-portable electronic devices and also to hand-portable electronic devices configured for hardware-initiated automated back-up.

### BACKGROUND TO THE INVENTION

U.S. Pat. No. 6,249,863 and U.S. Pat. No. 5,795,156 disclose the hardware-initiated automated launch of an application. A host device has an installed autostart driver. When a storage media is inserted into a drive of the host device, the autostart driver automatically starts an application on the storage media. This allows even pre-school children to use applications encoded on a storage media without adult supervision.

It is currently possible to backup data stored in a hand-portable electronic device such as a personal digital assistant (pda) or a cellular mobile telephone to a personal computer. This can be achieved by connecting the hand-portable device to a computer either via a physical serial data connection or a wireless connection such as IrDa or Bluetooth. In some portable electronic devices data is stored, in part, in memory modules such as SD or MMC memory cards inserted into the device. This data can be backed up by removing the card from the portable device, inserting it into a data card reader connected to the personal computer, copying the data to the computer and then reinserting the card into the device.

The data stored on a computer can be backed up onto removable data media such a CD-ROMs or DVD-ROMs, onto external hard drives or onto a server. It is known to have software running on the personal computer that automatically initiates a backup at a certain time. CMS market a backup hard drive, the ABSplus, which they claim is the only Automatic backup system on the market today. When the ABSplus is plugged into an Apple Macintosh computer it automatically initiates a complete backup of the computer's hard drive creating a fully bootable drive. Each time the unit is plugged in, powered on or scheduled, the ABSplus automatically copies only those files that have been changed or newly created since the last backup was performed. This unit, however, only has a single dedicated backup function, is relatively expensive and of a relatively large size compared to hand-portable electronic devices and is connected to the computer via USB 2.0, Firewire or PCMIA.

It would be desirable to improve the facilities for backing-up data stored in the internal memory of a hand-portable device.

### BRIEF DESCRIPTION OF THE INVENTION

According to one embodiment of the invention there is provided a hand-portable electronic device configured for hardware-initiated automated back-up, comprising: an internal memory for storing data; an interface for connection and disconnection to any one of a plurality of generic memory modules; a user interface that enables a user of the device to specify the generic memory module connected to the interface for automated back-up of data stored in the internal memory; a controller for automatically backing up data, on connection of a generic memory module to the interface, from the internal memory to the connected generic memory module if the connected generic memory module is identified as a generic memory module that has previously been specified for back-up via the user interface.

According to another embodiment of the invention there is provided a system for automated back-up of an internal memory of a hand-portable electronic device, comprising: a generic memory module; and a hand-portable electronic device comprising: an internal memory for storing data; an interface for connection and disconnection to any one of a plurality of generic memory modules; a user interface that enables a user of the device to specify a generic memory module connected to the interface for automated back-up of data stored in the internal memory; a controller for automatically backing-up data, on connection of a generic memory module to the interface, from the internal memory to the connected generic memory module if the connected generic memory module is identified as a generic memory module that has previously been specified for back-up via the user interface.

According to another embodiment of the invention there is provided a method for backing-up data stored in an internal memory of a hand-portable electronic device, comprising: connecting the hand-portable device to a generic memory module; specifying the generic memory module connected to the interface for automated back-up of data stored in the internal memory; backing up data from the internal memory to the connected, specified memory module; disconnecting the hand-portable device from the specified memory module; automatically backing-up data from the internal memory to the specified memory module, whenever the specified memory module is subsequently connected to the device.

### BRIEF DESCRIPTION OF THE DRAWINGS

For a better understanding of the present invention reference will now be made by way of example only to the accompanying drawings in which:

FIG. 1 schematically illustrates a system for automatically backing-up an internal memory of a hand-portable electronic device on the insertion of a memory module into the device;

FIG. 2 schematically illustrates the process of specifying a memory module for automated back-up; and

FIG. 3 schematically illustrates the process of memory module initiated automated back-up.

### DETAILED DESCRIPTION OF EMBODIMENTS OF THE INVENTION

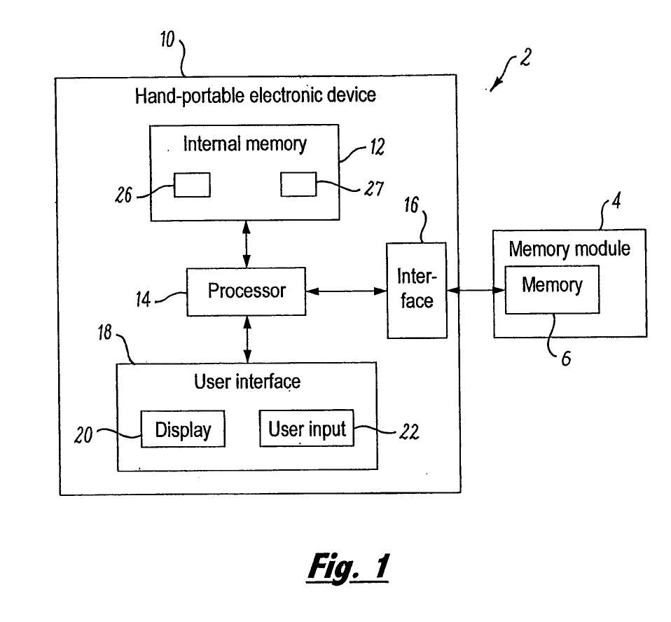

FIG. 1 schematically illustrates a system 2 for automatically backing-up an internal memory 12 of a hand-portable electronic device 10 on the insertion of a memory module 4 into the device 10. The hand-portable electronic device 10 is configured for hardware-initiated automated back-up. The hardware that initiates the back-up is the memory module 4.

The memory module not only initiates an automated back-up when it is inserted into the device 10 but it also stores the backed-up data. The memory module 4 is generic in the sense that it is not a type of memory that is dedicated for back-up only but has additional more general uses. It is a type of memory that can be used for back-up but it can also be used in other applications in the device where data storage is required and can be used in devices that are not configured for hardware initiated automated back-up.

Typically the memory module is a memory card or memory stick that comprises non-volatile solid-state memory 6 such as, for example, Flash EEPROM memory. Examples of suitable memory modules are Secure Digital (SD) cards or Multi-Media Cards (MMC).

A particular memory module 4 can be specified for automated back-up of a particular hand-portable electronic device 10 as described in more detail below. Once the particular memory module 4 has been specified in this way, whenever it is subsequently inserted into the particular hand-portable electronic device 10 it initiates automatic back-up of data from the internal memory 12 of the hand-portable device 10 to the inserted memory module 4.

As the back-up procedure is automatic when a specified memory module is inserted, it should be appreciated that although a memory module, before its specification for back-up, can be used for data storage other than back-up in the hand-portable device 10, after specification for back-up, it will automatically be used for back-up whenever it is inserted.

The hand-portable device 10 is able to recognize an inserted memory module 4 as one that is specified for back-up for that device 10 by reading an identifier from the memory module 4. This identifier may be an identifier that uniquely identifies the memory module that is permanently stored in the memory module 4, or, alternatively, it may have been written to the memory module 4 when it was specified for back-up.

The hand-portable electronic device 10 comprises: an internal memory 12 for storing data including a data structure 26; an interface 16 for connection and disconnection to an inserted memory module 4; a user interface 18; and a processor 14.

The processor 14 is connected so that it can read from and write to the internal memory 12. The processor 14 is also connected to the interface 16, so that it can read from and write to the solid state memory 6 of an inserted memory module 4. The processor 14 is also connected to the user interface 18.

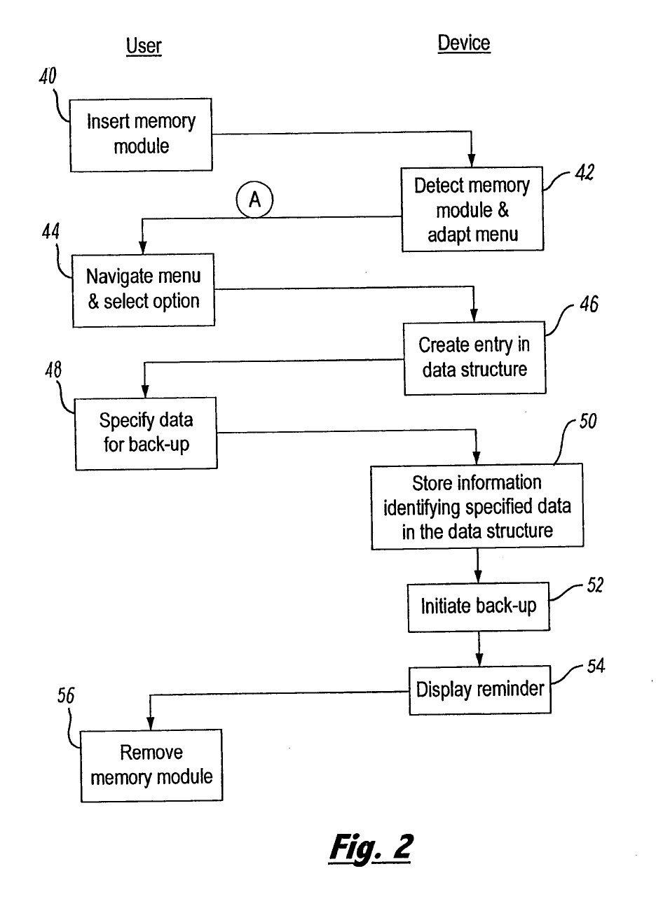

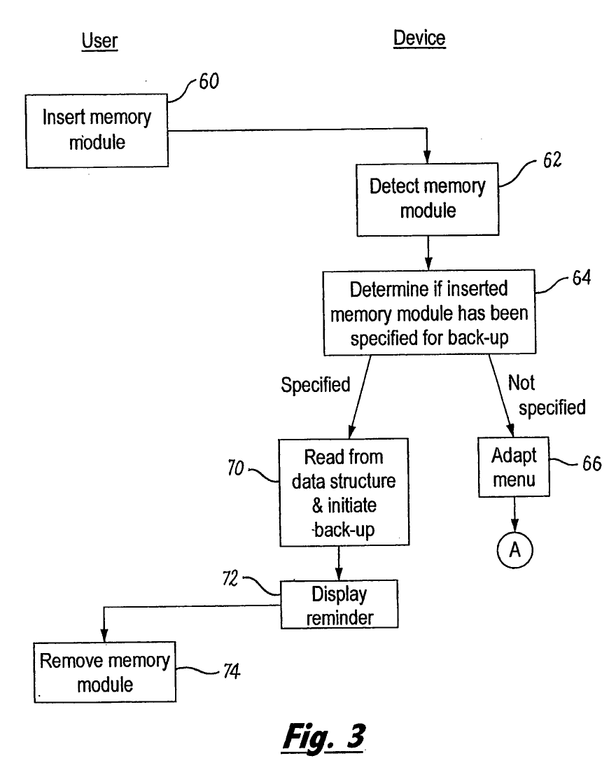

The internal memory 12 stores computer program instructions 27 that control the operation of the hand-portable electronic device 10 when loaded into the processor 14. The computer program instructions 27 provide the logic and routines that enables the electronic device to perform the methods illustrated in FIGS. 2 and 3. The computer program instructions may arrive at the hand-portable electronic device 2 via an electromagnetic carrier signal that is received via a radio transceiver (not shown) or a galvanic connection or they may be copied from a physical entity such as a computer program product, a memory device or a record medium such as a CD-ROM or DVD.

The user interface 18 comprises a display 20 and a user input device 22. The user interface is used to provide a hierarchical menu for navigation by a user. The menu includes an option that enables a user of the device 10 to specify an inserted memory module 4 for automated back-up. This option is typically only available when a memory module 4 has been inserted into the device 10. The hierarchical menu is consequently adaptive as it changes when an unspecified memory module 4 is inserted into the device 10.

When an inserted memory module 4 is specified for back-up, the menu also provides options for specifying which data stored in the internal memory 12 is to be backed-up. For example, there may be an option to back-up all data and/or an option to back-up user-dependent data such as contacts data.

The display 20 of the user interface 10 may notify the user when a memory module 4 has been inserted into the device and, after back-up of data to the inserted memory module 4, may notify the user to remove the memory module 4. This ensures that the backed up data is removed and stored separately from the data in the internal memory 12, so that loss of the device 10 does not result in loss of the backed-up data.

The processor 14 operates as a controller for automatic back-up. It controls the automatic back-up of data, on connection of a memory module 4 to the interface 16. This connection occurs automatically when the memory module 4 is inserted into the device 10.

The processor 14, on insertion of a memory module 4, attempts to identify whether the inserted memory module has previously been specified for back-up by the device 10.

If the connected memory module is identified as a memory module that has previously been specified for back-up, then the processor 14 automatically reads data from the internal memory 12 and writes it to the memory 6 of the connected memory module 4. Once the back-up is complete, the processor 14 controls the display 20 to display a reminder to the user to remove the memory module 4 from the device 10.

If the connected memory module is not identified as a memory module that has previously been specified for back-up, then the processor 14 automatically adapts the menu presentable by the user interface 18 to include an additional option for specifying the inserted memory module 4 for back-up. This option will not typically be presented automatically when a memory module is inserted. Some navigation of the menu will be required to be presented with this new additional option.

The interface 16 comprises galvanic contacts that mate with corresponding galvanic contacts on an inserted memory module 4 to form an electrical connection between the interface 16 and the memory module 4. In one embodiment, sensing circuitry is used to sense the change in an electrical characteristic (resistance or capacitance) of the interface's galvanic contacts when they connect to those of the memory module 4. The sensing circuitry can therefore detect the formation of a connection between the interface 16 and an inserted memory module 4. Other mechanisms may alternatively be used to detect the formation of such a connection. For example, the hand-portable device 10 may comprise a slotted aperture to a receptacle for receiving the memory module 4, if it's a card. The receptacle may include a mechanical switching element that is switched when a memory module 4 is fully inserted into the receptacle.

The memory 12 is used to store a data structure 26. This data structure stores the identifier of each memory module 4 that has been specified for back-up and stores, in association with each identifier, details of what data has been specified for automated back-up when the memory module identified by that identifier is inserted into the device 10.

The processor 14 uses the data structure 26 to identify when the newly connected memory module 4 is one that has previously been specified for back-up. The processor 14 automatically attempts to read predetermined data from a memory module 4 as soon as it has been inserted. The read data is compared to the identifier(s) stored in the data structure 26. If there is a match a back-up is automatically started by the processor 14. The processor 14 backs up to the inserted memory module 4 the data that is specified in the data structure in association with the matched identifier.

In a first embodiment, when the user specifies an inserted memory module for automated back-up via the user interface, the processor writes an identifier to a predetermined memory address of the memory module 4 and to the data structure 26. The identifier may have a predetermined content. When a memory module 4 is subsequently inserted, the processor 14 automatically attempts to read data from the predetermined memory address of the memory module 4. The read data is then compared to the identifier stored in the data structure 26. If the read data matches the stored identifier then it is determined that the inserted memory module 4 has previously been specified for automated back-up.

In a second embodiment, when the user specifies an inserted memory module 4 for automated back-up via the user interface 18, the processor 14 reads an identifier from a predetermined memory address of the memory module 4 and writes it to the data structure 26. The identifier may be permanently stored in and uniquely identify the memory module 4. When a memory module 4 is subsequently inserted, the processor 14 automatically attempts to read data from the predetermined memory address of the memory module 4. The read data is then compared to the identifier stored in the data structure 26. If the read data matches the stored identifier then it is determined that the inserted memory module 4 has previously been specified for automated back-up.

The process of specifying a memory module is schematically illustrated in FIG. 2. At step 40, the user inserts a memory module into the hand-portable device. At step 42, the device 10 detects the presence of a memory module 4 that has not previously been specified for back-up and adapts its hierarchical menu to include an option for specifying an inserted memory module 4 for automated back-up. At step 44, the user navigates the menu and selects the option that specifies the inserted memory module for automated back-up. Then at step 46, the device 10 creates a new entry in the data structure 26 that includes an identifier for the currently inserted memory module 4. This identifier may have originated in the device 10 or in the memory module 4. Then at step 48, the user specifies what data should be automatically backed up when the currently inserted memory module 4 is inserted in the future. The user may specify that all or some of the data should be backed up. At step 50, the device 10 enters this information into the new entry in the data structure 48. At step 52, the device performs a back-up of the specified data from the internal memory 12 to the inserted memory module 4. After completion of the back-up, at step 54, the device 10 displays a notice that reminds the user to remove the memory module 4 from the device 10. At step 56, the user removes the memory module 4 from the device 10.

The process of hardware initiated automated back-up is schematically illustrated in FIG. 3. At step 60, the user inserts a memory module into the hand-portable device. At step 62, the device 10 detects the presence of the memory module 4. At step 64 the device determines whether the inserted memory module is one that has previously been specified for back-up. It reads data from the memory module 4 and compares it with identifier data in the data structure 26. If a match is found the process moves to step 70, if no match is found the process moves to step 66.

At step 66, the device 10 adapts its hierarchical menu to include an option for specifying an inserted memory module 4 for automated back-up. The user if they wish navigate to this option and perform the process illustrated in FIG. 2.

At step 70, the information identifying the data specified for back-up is read from the data structure 26 and the back-up of the specified data from the internal memory 12 to the inserted memory module is initiated. After completion of the back-up, at step 72, the device 10 displays a notice that reminds the user to remove the memory module 4 from the device 10. At step 74, the user removes the memory module 4 from the device 10.

In the above described implementation, the memory module is used only for back-up after it has been specified for backup and is removed after backup is complete. However, in other implementations, the memory module may be used for backup and for normal data storage, other than backup, after its specification for backup. In this implementation the memory module is not necessarily removed immediately after backup but remains and is used for data storage. In this implementation, the user may at step 48 create a folder in the memory of the inserted memory module 4 that is used for backup purposes. This allows the new folder to be used for automatic backup and other folders to be used for storing data in a normal way so that pictures, sound etc can be saved directly to the inserted memory module. In this implementation, after completion of the back-up, at step 54/72, the device 10 need not necessarily display a notice that reminds the user to remove the memory module 4 from the device 10. The memory module 4 may remain in the device 10 and subsequently can be used for storing data and need not be immediately removed as illustrated in step 56/74. Thus in FIG. 2, the process may or may not include the step 54 of displaying a reminder and step 56 is de-coupled from steps 53 and 54. Likewise in FIG. 3, the process may or may not include the step 72 of displaying a reminder and step 74 is de-coupled from steps 70 and 72.

In some implementations of the invention, the only automated backup facility that is available on the device 10 is that initiated by inserting a specified memory module 4. In this case, automated backup only occurs on insertion of a specified memory module 4 and not at any other time.

As the back-up procedure is automatic when a specified memory module is inserted, it should be appreciated that although a memory module, before its specification for back-up, can be used for data storage, other than back-up, in the device 10, after specification for back-up, it will automatically be used for back-up whenever it is inserted.

It will be appreciated in the foregoing, that in the implementation described different memory modules may be used to back-up different data stored in the device 10. However, in other implementations only the use of a single memory module 4 for back-up is supported.

Although embodiments of the present invention have been described in the preceding paragraphs with reference to various examples, it should be appreciated that modifications to the examples given can be made without departing from the spirit and scope of the invention.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A hand-portable electronic device configured for hardware-initiated automated back-up, comprising:
an internal memory for storing data;
an interface for connection and disconnection to any one generic memory module of a plurality of generic memory modules;
a user interface that enables a user of the device to specify the generic memory module connected to the interface for automated back-up of data stored in the internal memory; and
a controller for automatically backing up data, on connection of the generic memory module to the interface, from the internal memory to the connected generic memory module if the connected generic memory module is identified as a generic memory module that has previously been specified for back-up via the user interface.

2. A hand-portable electronic device as claimed in claim 1, configured to detect a newly connected generic memory module to the interface; and configured to identify when the newly connected generic memory module is a generic memory module that has previously been specified for back-up via the user interface, wherein the controller is configured to perform automatic back-up if the newly connected generic memory module is identified as a generic memory module that has previously been specified for back-up via the user interface and to not perform automatic back-up if the newly connected generic memory module is not identified as a particular generic memory module that has previously been specified for back-up via the user interface.

3. A hand-portable electronic device as claimed in claim 2, wherein the controller is operable, in response to a specification via the user interface of a connected data module as a data module for automated back-up, to store at a predetermined memory address of the data module a predetermined identifier and is subsequently operable to identify a newly connected generic memory module as one specified for automated back-up by reading data from the predetermined memory address of the newly connected data module and by comparing the read data with the predetermined identifier.

4. A hand-portable electronic device as claimed in claim 2, wherein the controller is operable, in response to a specification via the user interface of a connected data module as a data module for automated back-up, to read from the data module an identifier of the data module permanently stored in the data module and to store the read identifier in a data structure in the internal memory and is operable to identify a newly connected generic memory module as one specified for automated back-up by reading the identifier from the memory module and comparing the read identifier with the identifier stored in the data structure.

5. A hand-portable electronic device as claimed in claim 1, wherein the device has a body and is configured to enable user-controlled insertion of a memory module into the body of the device to form a connection with the interface and user-controlled removal of the inserted memory module from the body to disconnect the inserted memory module from the interface.

6. A hand-portable electronic device as claimed in claim 1, wherein a generic memory module is additionally usable for data storage in devices that are not configured for hardware initiated automated back-up.

7. A hand-portable electronic device as claimed in claim 1, wherein a generic memory module, before specification for back-up, is usable for data storage, other than back-up, in the device.

8. A hand-portable electronic device as claimed in claim 1, wherein a generic memory module, after specification for automated back-up of data, is additionally usable for data storage, other than backup, in the device.

9. A hand-portable electronic device as claimed in claim 1, wherein a memory module is a memory card comprising solid state memory.

10. A hand-portable electronic device as claimed in claim 1, wherein the user interface is used to specify which of the data stored in the internal memory are to be backed-up.

11. A hand-portable electronic device as claimed in claim 1, wherein the user interface reminds the user to disconnect the memory module from the interface after automated back-up is completed.

12. A computer program comprising program instructions which, when loaded into a processor, provide the controller of claim 1 with said program instructions for said automatically backing up data.

13. A system for automated back-up of an internal memory of a hand-portable electronic device, comprising:
a generic memory module; and
a hand-portable electronic device comprising:
an internal memory for storing data;
an interface for connection and disconnection to any one of a plurality of generic memory modules;
a user interface that enables a user of the device to specify a generic memory module connected to the interface for automated back-up of data stored in the internal memory; and
a controller for automatically backing-up data, on connection of a generic memory module to the interface, from the internal memory to the connected generic memory module if the connected generic memory module is identified as a generic memory module that has previously been specified for back-up via the user interface.

14. A generic memory module for use in the system of claim 13.

15. A method for backing-up data stored in an internal memory of a hand-portable electronic device, comprising:
connecting the hand-portable device to a generic memory module;
specifying the generic memory module connected to the interface for automated back-up of data stored in the internal memory;
backing up data from the internal memory to the connected, specified memory module;
disconnecting the hand-portable device from the specified memory module;
automatically backing-up data from the internal memory to the specified memory module, whenever the specified memory module is subsequently connected to the device.

16. A method as claimed in claim 15, further comprising:
detecting a connection of a generic memory module to the hand-portable device; and
identifying the connected generic memory module as a particular generic memory module that has previously been specified for back-up via the user interface.

17. A method as claimed in claim 16, further comprising:
storing a predetermined identifier at a predetermined memory address of a data module connected to the hand-portable device, wherein the identifying of the connected generic memory module comprises:
reading data from the predetermined memory address of the connected generic memory module; and comparing the read data with the predetermined identifier.

18. A method as claimed in claim 16, further comprising:
reading, from a data module connected to the hand-portable device, an identifier of the data module that is stored in the data module, and storing the read identifier in a data structure in the internal memory, wherein the step of identifying the connected generic memory module comprises:
reading the identifier from the generic memory module; and comparing the read identifier with the identifier stored in the data structure.

19. A method as claimed in claim 15, inserting a memory connecting the hand-portable device to a generic memory module comprises inserting a memory module into a body of the hand-portable device and disconnecting the hand-portable device from the inserted generic memory module comprises removing the inserted memory module from the body of the hand-portable device.

20. A method as claimed in claim 15, wherein a generic memory module is usable for data storage in other devices then the hand-portable device that are not configured for hardware initiated automated back-up.

21. A method as claimed in claim 15, wherein a generic memory module, before specification for back-up, is usable for data storage, other than back-up, in the hand-portable device.

22. A method as claimed in claim 15, wherein a generic memory module, after its specification for automated back-up of data, is additionally usable for data storage, other than backup, in the hand-portable device.

23. A method as claimed in claim 15, further comprising, when the back-up has been completed, notifying the user that the memory module should be disconnected.

24. A memory module storing data for initiating an automated back-up when the memory module is connected to hand-portable electronic device as claimed in claim 1.

25. A computer program comprising program instructions which when run on a processor provide:
means for enabling a user to specify a generic memory module for automated back-up of data; and
control means for automatically initiating back up of data, on connection of a generic memory module to the interface, from an internal memory to the connected generic memory module if the connected generic memory module is identified as a generic memory module that has previously been specified for back-up.

26. A computer program as claimed in claim 25 further comprising program instructions which when run on a processor further provide:
identifier means for identifying when a newly connected generic memory module is a generic memory module that has previously been specified for back-up, wherein the control means is responsive to the identifier means to perform automatic back-up if the newly connected generic memory module is identified as a generic memory module that has previously been specified for back-up and the control means does not perform automatic back-up if the newly connected generic memory module is not identified as a particular generic memory module that has previously been specified for back-up.

27. A computer program as claimed in claim 26, wherein the control means is operable, in response to the specification of a connected data module as a data module for automated back-up, to store at a predetermined memory address of the data module a predetermined identifier and wherein the identifier means is subsequently operable to identify a newly connected generic memory module as one specified for automated back-up by reading data from the predetermined memory address of the newly connected data module and by comparing the read data with the predetermined identifier.

28. A computer program as claimed in claim 26, wherein the control means is operable, in response to the specification via the user interface of a connected data module as the data module for automated back-up, to read from the data module an identifier of the data module permanently stored in the data module and to store the read identifier in a data structure in the internal memory and wherein the identifier means is operable to identify a newly connected generic memory module as one specified for automated back-up by reading the identifier from the memory module and comparing the read identifier with the identifier stored in the data structure.

29. A physical entity embodying the computer program as claimed in claim 25.

30. An electromagnetic carrier signal carrying the computer program as claimed in claim 25.
